(19) United States
(12) Patent Application Publication
(10) Pub. No.: US 2023/0350407 A1
(43) Pub. Date: Nov. 2, 2023

(54) AUTONOMOUS AGRICULTURAL PRODUCTION MACHINE

(71) Applicant: CLAAS E-Systems GmbH, Dissen a.T.W. (DE)

(72) Inventors: Reinhold Mähler, Rheda-Wiedenbrück (DE); Christian Ehlert, Bielefeld (DE); Bastian Bormann, Gütersloh (DE); Joachim Baumgarten, Beelen (DE); Dennis Neitemeier, Lippetal (DE); Johann Witte, Fröndenberg (DE); Jannik Redenius, Oldendorf (DE); Arne Bohl, Gütersloh (DE); Eberhard Nacke, Gütersloh (DE); Christoph Apke, Bielefeld (DE); Timo Korthals, Leopoldshöhe (DE); Waldemar Thiesmann, Osnabrück (DE); Axel Schröder, Gütersloh (DE); Robin Monkenbusch, Rheda-Wiedenbrück (DE)

(73) Assignee: CLAAS E-Systems GmbH, Dissen a.T.W. (DE)

(21) Appl. No.: 18/139,520

(22) Filed: Apr. 26, 2023

(30) Foreign Application Priority Data
Apr. 27, 2022 (DE) 10 2022 110 132.0

(51) Int. Cl. G05D 1/00

(52) U.S. Cl. CPC G05D 1/0027; G05D 1/0022; G05D 1/0088; G05D 2201/0201

(57) ABSTRACT

An assistance system based on electronic data exchange for enabling an autonomous vehicle to act as an autonomous agricultural production machine and an autonomous agricultural production machine is disclosed. The assistance system is configured to plan the deployment of at least one autonomous vehicle, to transmit the information required for the deployment to the autonomous vehicle, to at least partially control the autonomous vehicle during working mode and to monitor the working mode of the autonomous vehicle.

### CROSS REFERENCE TO RELATED APPLICATIONS

This application claims priority under 35 U.S.C. § 119 to German Patent Application No. DE 10 2022 110 132.0 filed Apr. 27, 2022, the entire disclosure of which is hereby incorporated by reference herein. This application incorporates by reference herein the following U.S. Applications in their entirety: U.S. Application No. entitled “SWARM ASSISTANCE SYSTEM AND METHOD FOR AUTONOMOUS AGRICULTURAL UNIVERSAL PRODUCTION MACHINES” (attorney docket no. 15191-23005A (P05576/8)); U.S. Application No. entitled “METHOD AND SYSTEM FOR MONITORING AUTONOMOUS AGRICULTURAL PRODUCTION MACHINES” (attorney docket no. 15191-23006A (P05578/8)); U.S. Application No. entitled “METHOD AND SYSTEM FOR MONITORING OPERATION OF AN AUTONOMOUS AGRICULTURAL PRODUCTION MACHINE” (attorney docket no. 15191-23007A (P05580/8)); and U.S. Application No. entitled “SYSTEM AND METHOD FOR DEPLOYMENT PLANNING AND COORDINATION OF A VEHICLE FLEET” (attorney docket no. 15191-23008A (P05585/8)).

### TECHNICAL FIELD

The present application relates to an assistance system based on electronic data exchange for enabling an autonomous vehicle to act as an autonomous agricultural production machine, and to a corresponding autonomous agricultural production machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In modern agriculture, efforts are increasingly being made to perform jobs autonomously in order to increase the productivity and economy of the processes. For this purpose, so-called autonomous agricultural production machines are deployed which may be characterized by the fact that there is no operator in a cabin to control them. Accordingly, with autonomous agricultural production machines, no operator is available who understands an agricultural work process to be performed with a sequence of different work steps and may perform individual control functions while the production machine is operating on an agricultural area. Such autonomous agricultural production machines may therefore also be referred to as unmanned agricultural production machines.

For example, WO2015/173073A1 discloses a method for harvesting harvested materials using manned agricultural production machines and unmanned agricultural production machines, i.e. autonomous agricultural production machines. The operation and the distance covered by an unmanned agricultural production machine during its operation on an agricultural area are controlled in this case by the operator of a manned agricultural production machine.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 shows a schematic view of the assistance system.

FIG. 2 shows a detailed description of the method with an example of a fleet of machines.

FIG. 3 shows a schematic representation of the construction of the autonomous agricultural production machine.

### DETAILED DESCRIPTION

As discussed in the background, WO2015/173073A1 discloses an operator of the manned agricultural production machine visually monitoring the operation of the unmanned agricultural production machines and controlling the unmanned agricultural production machines according to the planned use via wireless remote control. Specifically, the operator is continuously in the immediate vicinity of the autonomous agricultural production machines during their operation. The operator of the manned agricultural production machine is therefore able to visually monitor the operation of the unmanned agricultural production machines and to control the unmanned agricultural production machines according to the planned use via wireless remote control. A disadvantage of such a method is that the operation of the autonomous agricultural production machine is necessarily linked to the presence of an operator of a manned agricultural production machine who is always in the immediate vicinity of the unmanned agricultural production machine in order to be able to control it remotely. Although, in principle, work steps may be performed autonomously by the unmanned production machines, the proximity of a person is always required for the autonomous agricultural production machine to perform the work steps.

Thus, in one or some embodiments, an autonomous agricultural production machine is disclosed that is configured to perform autonomous (or automatic) execution of working steps without the need for a person to be in the vicinity of the autonomous agricultural production machine in order to monitor the operation of the autonomous agricultural production machine and control it during execution. Thus, in one or some embodiments, any discussion herein regarding autonomous may comprise automatic operation without any human intervention.

Specifically, an assistance system (such as an agricultural production machine assistance system) may operate based on electronic data exchange and may be configured to enable the agricultural production machine to act as an autonomous agricultural production machine. The assistance system may include at least one communication interface configured to receive the electronic data (e.g., perform the electronic data exchange) and at least one processor in communication with the communication interface and configured to: plan the deployment of the agricultural production machine; transmit information required for the deployment to the autonomous vehicle, to at least partially control the autonomous vehicle during working mode (e.g., transmit one or more commands to the agricultural production machine in order to control the agricultural production machine so that it acts as an autonomous agricultural production machine); and monitor the working mode of the autonomous agricultural production machine (e.g., monitor one or more aspects of the agricultural production machine at least partly during the deployment). In this way, the assistance system may ensure that the autonomous agricultural production machine may autonomously execute working steps without a person having to be in the vicinity of the autonomous agricultural production machine in order to monitor the operation of the autonomous agricultural production machine and control it during execution.

In one or some embodiments, the assistance system comprises any one, any combination, or all of: one or more data processing devices; one or more data receiving devices; and one or more data transmitting devices, wherein the one or more data processing devices, the one or more data receiving devices, and the one or more data transmitting devices may be associated with one or more autonomous vehicles and an external server. In particular, this may have the effect of allowing the one or more autonomous agricultural production machines to communicate with each other and with a server so that autonomous control and monitoring of the autonomous agricultural production machines may take into account complex relationships to safely control and regulate each of the autonomous agricultural production machines.

In order to have the extensive volumes of data required for controlling and monitoring the autonomous agricultural production machines available at some or all times, in one or some embodiments, the external server may be designed as a data cloud.

In order that the creation of the autonomous agricultural production machine may be limited to the measures related to the particular application, it is further provided that the autonomous agricultural production machine is derived from an autonomous vehicle which is unmanned and already independently may perform driving movements and work activities.

In one or some embodiments, a customer-specific deployment plan is transferred to the assistance system (e.g., received via the communication interface), wherein the customer-specific deployment plan may describe a service to be provided, at least in terms of one or both of type and scope. In particular, this may have the effect that the assistance system may completely independently create the autonomous agricultural production machine tailored to the specific application.

In one or some embodiments, the assistance system is configured to determine (such as automatically determine) a required number of autonomous vehicles from the deployment plan in a deployment planning module in a result step and is configured to arrange (such as automatically arrange) for their provision. This may have the particular effect that the creator of the deployment plan, such as the customer or user, has nothing to do with the procurement of the suitable agricultural production machines.

Because the assistance system is configured to assign (such as automatically assign) information and equipment to the autonomous vehicle from the deployment plan in a required information module in a result step so that the autonomous vehicle may automatically execute driving movements and work activities derived from the customer-specific deployment plan, it may be ensured that the created autonomous agricultural production machine is designed and may be automatically controlled and automatically monitored in such a way that it may optimally fulfill the customer-specific deployment plan. In this context, it may also be advantageous for the assistance system to be configured to assign (such as automatically assign) information and equipment to the autonomous vehicle in a result data record that automatically transforms the autonomous vehicle into an autonomous agricultural production machine that may optimally automatically execute (e.g., fulfill) the deployment plan defined by the customer.

In one or some embodiments, the assistance system is configured to generate (such as automatically generate) a result data record from the deployment plan in a control module which may comprise control data that automatically controls the particular autonomous agricultural production machine when at least partly implementing the determined driving movements and work activities so that any human intervention during the activities to be performed by the autonomously acting agricultural production machine becomes unnecessary. In this context, in one or some embodiments, it may be advantageous if the result data record is limited to basic data, and the complete automatic control of the autonomous agricultural production machine to realize or to cause the driving movements and the work activities may be automatically performed by the autonomous agricultural production machine itself. In this way, the influence of data transmission problems (e.g., breakdowns in communication) between an external server and the particular autonomous agricultural production machine is reduced and ideally avoided altogether.

In one or some embodiments, the assistance system is configured to automatically monitor the driving movement and work activity of the one or more autonomous agricultural production machines in a monitoring module, and configured to automatically intervene in the automatic controlling of the particular autonomous agricultural production machine responsive to automatically identifying one or more situations (e.g., critical situations), and therefore may ensure that the autonomously operating agricultural production machine does not pose a risk to third parties, and that damage to the agricultural production machine itself may be avoided. In this way, it may be ensured that the autonomously operating agricultural production machine does not leave the territory assigned to it and does not collide with other vehicles or obstacles present in the territory to be worked. In addition, the automatic monitoring may ensure that the autonomous agricultural production machine may automatically perform a work activity that is high-quality.

In one or some embodiments, efficient realization of the automatic monitoring function may be achieved if at least the monitoring of the driving movement and the work activity of the one or more autonomous agricultural production machines is accomplished by automatically booking an external service for the one or more autonomous agricultural production machines. In particular, this may have the effect that a customer may therefore ensure safe operation of the particular autonomously acting agricultural production machine.

In one or some embodiments, a simple activation of the control and monitoring functions may result when the external service requested by one or more entities, such as one or both of: the at least one or more autonomous agricultural production machines (either automatically or triggered by input from an operator); a remote monitoring service or a remote control service (e.g., the customer is a remote monitoring service and/or a remote control service distant from the particular agricultural production machine, which may be enabled upon request (such as a request by the customer) and which may be configured to perform remote monitoring and/or remote control of the at least one or more autonomous agricultural production machines).

Thus, in one or some embodiments, the remote monitoring or the remote control service may be ordered (such as by a customer). In turn, the remote monitoring and/or remote control service may be implemented particularly efficiently and smoothly if the at least one agricultural production machine (to be automatically monitored and/or automatically controlled using the remote monitoring and/or remote control service) has means, such as any one, any combination, or all of: at least one data processing device; a data transmitting device; and a data receiving device for transmitting machine data and/or environment data at regular or irregular time intervals or in real time to a database assigned to a server. Further, in one or some embodiments, the machine data and/or environment data may be collected in the database and assigned to the particular autonomous agricultural production machine and may be linked to further available data from the immediate environment of the autonomous agricultural production machine. The machine data and/or environment data may be saved in the database of the server and may be structured in such a way that the assistance system may access the particular autonomous agricultural production machine at any time and take over its control.

In one or some embodiments, the monitoring function may further be enhanced if the remote monitoring and/or remote control service provides a geo-fence dataset, and the use of the geo-fence dataset by the one or more autonomous agricultural production machines may cause the movement of the at least one or more autonomous agricultural production machines to be limited to the territory to be worked, and may prevent escape from that territory.

In one or some embodiments, the assistance system is configured to automatically assign the one or more autonomous agricultural production machines to a main process as a supporter (e.g., a follower), wherein the assistance system is configured to automatically determine the need for support in an environment of the one or more autonomous agricultural production machines and is configured to automatically assign jobs to the available autonomous agricultural production machines depending on the identified need. In particular, this may have the effect that one or more of the autonomous agricultural production machines may be automatically integrated into existing agricultural process chains without causing problems in the cooperation of the manned or unmanned vehicles already involved or participating in a process chain with the newly added autonomous agricultural production machines.

In one or some embodiments, the customer may pay a usage fee for booking the remote monitoring and/or remote control service. The advantage for the customer may be that she/he buys the outfitting of the machines necessary for executing his deployment plan as well as their control and monitoring in a resource-saving manner similar to outsourcing without being directly involved in this process himself/herself.

By starting from an autonomous driverless agricultural production vehicle which may be configured to independently perform driving movements and work activities with at least partial use of the assistance system according to one embodiment, the autonomous driverless vehicle may be outfitted with information and equipment depending on a deployment in order to act as a specially configured autonomous agricultural production machine, and wherein the driving movements and work activities of the autonomous agricultural production machine may be at least partially automatically remotely monitored and/or automatically remotely controlled. In this way, it may be ensured that an autonomously acting agricultural production machine may be formed which may perform high-quality work activity and may also work safely.

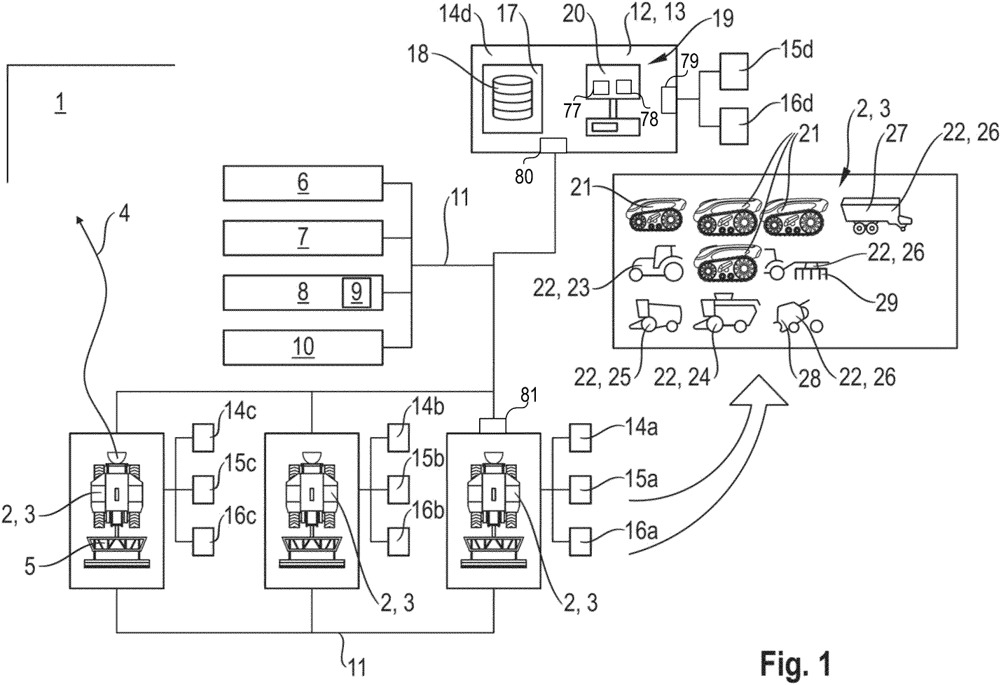

Referring to the figures, FIG. 1 shows an exemplary schematic representation of the assistance system 1 which may be based on electronic data exchange and which may be configured in a manner to be described in more detail to enable one or more autonomous vehicles 2 to act as autonomous agricultural production machines 3. The assistance system 1 may be remote from the one or more autonomous vehicles 2, such as at least one mile away, at least ten miles away, at least 100 miles away, etc. In one or some embodiments, characteristic of the autonomous vehicle 2 and the autonomous agricultural production machine 3 arising from it is that the autonomous vehicle 2 and the autonomous agricultural production machine 3 are unmanned and autonomously perform one or more driving movements 4 and/or one or more work activities 5. To make this possible, in one or some embodiments, the assistance system 1 is such that it may plan the deployment of one or more autonomous vehicles 2. For this purpose, the assistance system 1 may comprise deployment planning module 6. In order for the particular autonomous vehicle 2 to be able to independently perform driving movements 4 and specific work activities 5, the assistance system 1 may further comprise a required information module 7, wherein the assistance system 1 may obtain the required information in a manner to be described in more detail below and may transmit the required information to the particular autonomous vehicle 2. In order for the unmanned autonomous vehicles 2 to be able to perform the driving movements 4 and/or the work activities 5 required for the particular application with a high quality of work, it is further provided that the assistance system 1 comprises a control module 8 so that the assistance system 1 at least partially controls the driving movement 4 and the particular work activity 5. In this context, in one or some embodiments, the control module 8 only transmits (e.g., wirelessly transmits) basic data 9 to the particular autonomous vehicle 2, and that the complete control of the driving movement 4 and the particular work activity 5 may be performed by the particular autonomous vehicle 2 itself. Alternatively, or in addition, it is contemplated that the control of the driving movement 4 and/or the work activity 5 of one or more autonomous vehicles 2 is completely taken over by the assistance system 1 (e.g., the assistance system 1 generates commands, transmits those commands for wireless receipt by the respective autonomous vehicle 2, with the respective autonomous vehicle 2 executing the commands in order to the fully automatically control the driving movement 4 and/or the work activity 5 of the respective autonomous vehicle 2). Furthermore, in one or some embodiments, the assistance system 1 comprises a monitoring module 10 in which the working mode, such as at least the driving movement 4 and the particular work activity 5, may be monitored in a manner to be described in more detail below.

The assistance system 1 further comprises a data exchange 11 that is configured to exchange data (such as automatically exchange data) between various modules and/or devices, such as data exchange with any one, any combination, or all of: the modules 6 - 10 with each other; of one or all modules 6 - 10 with one or all autonomous vehicles 2; or between the autonomous vehicles 2. Alternatively, or in addition, the data exchange 11 of the assistance system may further be configured to exchange data (such as automatically exchange data) with an external server 12. In one or some embodiments, the external server 12 may be configured as a data cloud 13. In order for the assistance system 1 to be able to operate (such as automatically operate) in a manner according to one or more embodiments of the invention, the assistance system 1 first comprises one or more data processing devices 14a..n (with FIG. 1 illustrating data processing devices 14a, 14b, 14c), one or more data transmitting devices 15a..n (with FIG. 1 illustrating data transmitting devices 15a, 15b, 15c), and one or more data receiving devices 16a..n (with FIG. 1 illustrating data receiving devices 16a, 16b, 16c). In one or some embodiments, in order for the described data exchange 11 to be accomplished, one, some or each of the autonomous vehicles 2 and the one or, if applicable, more external servers 12 are assigned (such as automatically assigned) to at least one data processing device 14a..n in each case, at least one data transmitting device 15a..n in each case and at least one data receiving device 16a..n in each case. Moreover, each of the data processing devices 14a..n may comprise a memory unit 17 with at least one database 18 saved therein and a computing unit 19 which is set up to process data saved in the memory unit 17. In this regard, the data processing devices 14a..n may include at least one processor and at least one memory. Alternatively, the data processing devices 14a..n may comprise different processing threads. The computing unit 19 may also comprise an input/output unit 20 in which data may be automatically retrieved from the database 18, input or changed. The memory unit 17 and the computing unit 19 may be arranged at a distance from each other. Alternatively, the memory unit 17 and the computing unit 19 may be integrated with one another. The memory unit 17 and the computing unit 19 may communicate with each other using at least one network.

The computing unit 19 may comprise at least one processor 77 and at least one memory 78 that stores information and/or software, with the processor configured to execute the software stored in the memory. In one or some embodiments, the computing unit 19 may comprise any type of computing functionality, such as the at least one processor 77 (which may comprise a microprocessor, controller, PLA, or the like) and the at least one memory 78. The memory 78 may comprise any type of storage device (e.g., any type of memory). Though the processor 77 and the memory 78 are depicted as separate elements, they may be part of a single machine, which includes a microprocessor (or other type of controller) and a memory. Alternatively, the processor 77 may rely on memory 78 for all of its memory needs.

The processor 77 and memory 78 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The above discussion regarding the at least one processor 77 and the at least one memory 78 may be applied to other devices, such as to autonomous vehicle 2 and the autonomous agricultural production machine 3. Merely by way of example, autonomous vehicle 2 may receive basic data 9 to the particular autonomous vehicle 2, and using at least one processor (similar to processor 77) and at least one memory (similar to memory 78) may use basic data 9 for complete control of the driving movement 4 and the particular work activity 5 may be performed by the particular autonomous vehicle 2 itself. Alternatively, autonomous vehicle 2 may have its driving movement 4 and/or the work activity 5 controlled by being completely taken over by the assistance system 1 (e.g., autonomous vehicle 2 receives commands via its communication interface 81 and using its processor and its memory, automatically executes the commands to automatically perform the driving movement 4 and/or the work activity 5 under the complete control of the assistance system 1).

In one or some embodiments, the computing unit 19 may comprise one or more communication interfaces 79, 80, which may be in communication with the processor 77 and be configured to communicate electronic data (such as receive electronic data and/or transmit electronic data, such as information (e.g., commands) or the like). In this way, the computing unit 19 may be configured to communicate wired and/or wirelessly with one or more other electronic devices as described herein using communication interfaces 79, 80.

In one or some embodiments, the described modules 6 -10 may be part of the database 18 associated with the server 12. Alternatively, the described modules 6 -10 may be separate from the database 18 associated with the server 12.

Furthermore, in one or some embodiments, the autonomous vehicle 2 designed as an autonomous agricultural production machine 3 may comprise either a universal basic vehicle 21 or an already specifically designed basic vehicle 22, wherein the specifically designed basic vehicle 22 may be designed, for example, as a tractor 23, as a combine harvester 24, as a forage harvester 25 or as a so-called attachment 26, for example as a loader wagon, 27 baler 28 or forage harvester 29. Further, the autonomous vehicle 2 designed as an autonomous agricultural production machine 3 may include one or more communication interfaces, such as communication interface 80, which may be configured to communicate with one or more external electronic devices described herein, such as the assistance system 1.

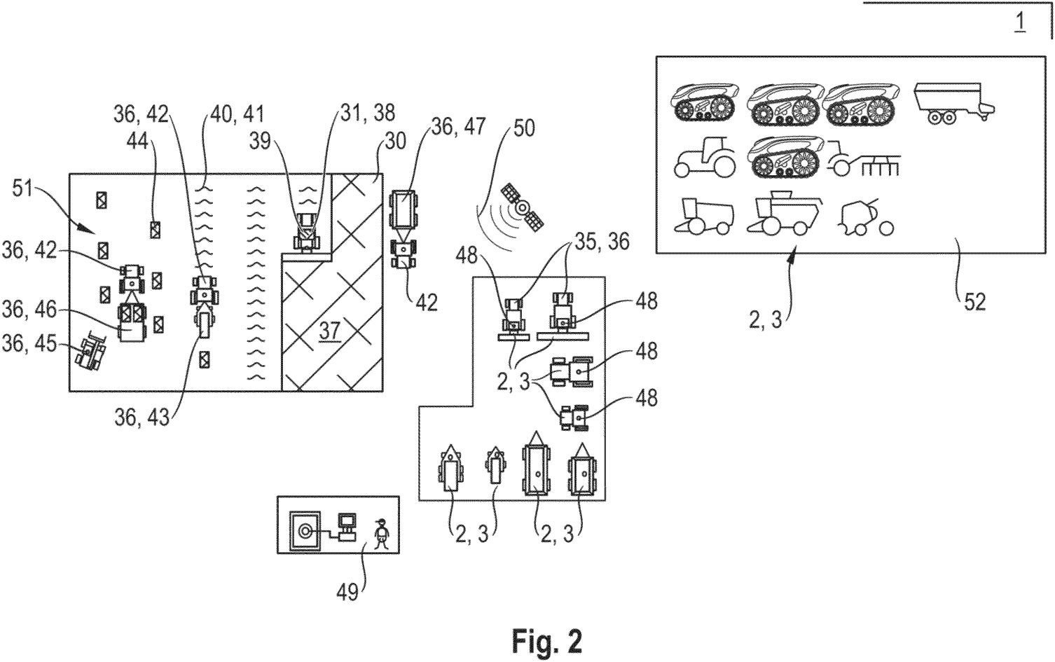

FIG. 2 schematically shows the assistance system 1 based on electronic data exchange according to one aspect of the invention using the example of a concrete agricultural application, namely the planning (such as automatic planning) of the process chain: harvesting (such as automatic harvesting) a cultivated area 30 and salvaging (such as automatic salvaging) the harvested material 31.

Under conventional conditions (e.g., the vehicles involved in the process are manned), the process chain, such as harvesting of a cultivated area 30 and recovery of the harvested material 31, may be structured as follows:

Initially, one or more agricultural production machines 36 configured as a combine 35 would harvest the crop 37 grown on a cultivated area 30. In the depicted embodiment, the part of the harvested material 31 formed by the fruit 38 (or other part of the crop) is temporarily saved in a grain tank 39 on the combine 35 while the remaining part of the harvested material 31, such as the straw 40, is deposited in swath 41 or windrows on the cultivated area 30. When the straw 40 deposited in windrows 41 has reached a moisture content that allows the straw 40 to be saved, a baler 43 pulled by a tractor 42 compresses the straw 40 into harvested material bales 44 that are first deposited on the cultivated area 30. In another step of the process chain, the harvested material bales 44 are loaded by so-called forklifts 45 onto platform trailers 46 towed by tractors 42, for example, and transported away for storage. Similarly, the fruit 38 temporarily saved in the grain tank 39 is taken by tractor-drawn transport trailers 47 and sent to storage or further processing. Modern agricultural production machines 36 also have transmitting and receiving units 48 through which they may communicate (such as wirelessly communicate) with further agricultural production machines 36 and/or stationary equipment 49, wherein the transmitting and receiving units 48 generally also receive satellite-generated GPS signals 50 which are then used, for example, to generate position data of the particular agricultural production machine 36. Also when process chains are processed using conventional agricultural production machines 36, the required agricultural production machines 36, the required machine fleet 51, are assembled from a vehicle fleet 52.

If this known process chain is to be executed using the assistance system 1 according to one aspect of the invention described above, some or all of the conventional, manned agricultural production machines 36 may be replaced by the autonomous vehicles 2 designed as autonomous agricultural production machines 3 according to one or more embodiments. Consequently, the machine fleet 51 required for processing the process chain selected by way of example may comprise manned and unmanned or exclusively unmanned agricultural production machines 3, 36 so that the vehicle fleet 52 from which the machine fleet 51 is composed also comprises manned and unmanned agricultural production machines 3, 36.

In view of the fact that the invention may be directed towards the creation of an autonomous (e.g. unmanned and/or entirely computer controlled for the automatic control of the driving movement 4 and/or the work activity 5) agricultural production machine 2 and an associated assistance system 1, manned agricultural production machines 36 will no longer be mentioned in the following. However, it is within the scope of the invention that manned agricultural production machines 36 may be integrated into the described agricultural process chains or those configured as desired.

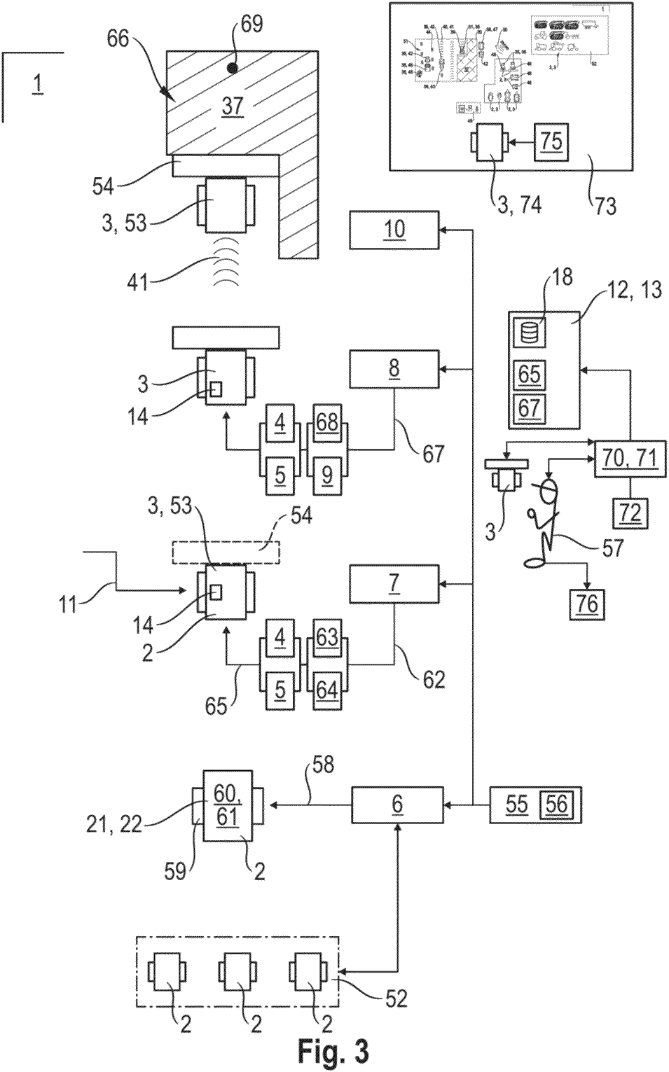

FIG. 3 schematically shows how an autonomous vehicle 2 may be converted into the autonomous agricultural production machine 3 according to one or some embodiments of the invention using the assistance system 1. In the example depicted here, the autonomous agricultural production machine 3 may comprise a self-propelled mower 53, which may be configured to harvest a crop 37 using a mowing attachment 54 and to deposit it in a swath 41. First, a customer-specific deployment plan 55 may be transmitted to the deployment planning module 6 of the assistance system 1. In one embodiment, the customer-specific deployment plan 55 may be transmitted from the autonomous vehicle 2. Alternatively, the customer-specific deployment plan 55 may be transmitted from other than the autonomous vehicle 2, such as a separate computer sitting on the Internet.

The deployment planning module 6 may then first determine (such as automatically determine) the number of needed autonomous vehicles 2 and may compile (such as automatically compile) their number from a vehicle fleet 52. It is contemplated that the autonomous vehicles 2 may be assembled from one or several vehicle fleets 52 and may include one or more autonomous vehicles 2. In the following, the creation of the autonomous agricultural production machine 3 will be described using a single autonomous vehicle 2 as an example. However, creating the autonomous agricultural production machine 3 using multiple autonomous vehicles 2 is contemplated.

The customer-specific deployment plan 55 is thereby such that it describes a service 56 to be provided at least in terms of type and/or scope. For example, the customer 57 may order the service 56 according to type and/or scope. If known, she/he specifies the particular deployment time, namely at least the period in which the service 56 is to be provided. Furthermore, the customer-specific deployment plan 55 may include the deployment location(s) and, if applicable, the sequence and type of work activities 5 to be performed.

The assistance system 1 may determine (such as automatically determine) a required number of autonomous vehicles 2 from the deployment plan 55 in the deployment planning module 6 in a result step 58, wherein the autonomous vehicle 2, as previously described, may be designed as a universal basic vehicle 21 or already as a specifically designed basic vehicle 22. In the illustrated exemplary embodiment, the specifically designed basic vehicle 22 would then be the already preassembled self-propelled mower 53, provided that such a self-propelled mower is available in a machine park.

The autonomous vehicle 2, irrespective of whether it is designed as a universal basic vehicle 21 or already as a specifically designed basic vehicle 22, may already be structured in a manner known per se, and therefore not described in detail here, in such a way that it has a chassis 59 and associated energy transmission means 60 as well as an energy source 61, such as an internal combustion engine or electric engine and possibly associated batteries.

After the suitable number of required autonomous vehicles 2 has been determined, the assistance system 1 may derive (such as automatically derive) information 63 and equipment 64 for the autonomous vehicle 2 in a result step 62 from the deployment plan 55 in a required information module 7 in the manner already described, so that the autonomous vehicle 2 may automatically execute driving movements 4 and work activities 5 derived from the customer-specific deployment plan 55. In the result step 62, a result data record 65 is generated, which may be automatically saved in the server 12 described above, which may be configured as a data cloud 13, and may be uniquely assigned to the particular autonomous vehicle 2. The driver assistance system 1 may also be structured in such a way that, when generating the information 63 to be assigned to the autonomous vehicle 2, it may take into account information from a wide variety of databases 18, which may be suitable for ensuring an optimized driving movement 4 and/or an optimized work activity 5 of the autonomous vehicle 2. In the exemplary embodiment depicted, the result data record 65 may comprise, among other things, information that ensures optimal operation of the mowing attachment 54. In addition, the result data record 65 may comprise information on how the autonomous vehicle 2 should move to the deployment location and/or on the territory 66 to be worked. The equipment 64 associated with the autonomous vehicle 2 in the result data record 65 may then be provided and attached to the autonomous vehicle 2. This may be done in such a way that the assistance system 1 identifies providers of the required equipment 64 and generates either instructions or orders to either supply the required equipment 64 for the autonomous vehicle 2, or orders the autonomous vehicle 2 to go to the required equipment 64. In all contemplated cases, the required equipment 64 may ultimately be attached to and/or in communication with the autonomous vehicle 2. The other information 63 of the result data record 65 may be transmitted directly to the data processing device 14 associated with the particular autonomous vehicle 2 using the data exchange 11 as previously described. As a result, the autonomous vehicle 2 may be transformed into an autonomous agricultural production machine 3, in this case a self-propelled mower 53, in accordance with one or some embodiments of the invention. It is within the scope of the invention that, depending on the customer-specific deployment plan 55, a wide variety of information 63 and required equipment 64 may be determined and compiled by the assistance system 1 so that any type of autonomous agricultural production machine 3 may be created, such as any one, any combination, or all of: combine harvesters 24; forage harvesters 25; tractors 23; any type of attachment 26; loader wagons 27; balers 28; forage harvesters 29; soil cultivation machines; sowing and planting machines and manure spreaders; to name just a few by way of example.

After the one or more autonomous agricultural production machines 3 are assembled based on the result data record 65, the assistance system 1 may determine another result data record 67 from the deployment plan 55 in the control module 8 previously described, the other result data record 67 comprising control data 68 that controls the particular autonomous agricultural production machine 3 while implementing the determined driving movements 4 and work activities 5. The additional result data record 67 may be limited to basic data 9, wherein the complete control of the autonomous agricultural production machine 3 for realizing the driving movements 4 and the work activities 5 is effected by the autonomous agricultural production machine 3 itself. In particular, this may have the advantage that the autonomous agricultural production machine 3 may organize itself depending on its specific operating conditions and, moreover, does not depend on a permanent connection with the server 12 for the purpose of data exchange 11. The result data record 65 may be saved in the server 12 described above, which may be configured as a data cloud 13, and may be uniquely assigned to the particular autonomous vehicle 2.

After the particular autonomous agricultural production machine is prepared with information 63 and equipment 64, the assistance system 1 may use a monitoring module 10 to take over, in the manner already described, the monitoring of the driving movement 4 and the work activity 5 of the one or more autonomous agricultural production machines 3, and if critical situations are identified, for example obstacles 69 in the territory 66 to be worked or malfunctions in the work activity 5, the assistance system 1 is configured to intervene in the controlling of the particular autonomous agricultural production machine 3. It is further provided that at least the described monitoring of the driving movement 4 and the work activity 5 of the one or more autonomous agricultural production machines 3 may be triggered by the automated booking 70 of an external service 71 for the one or more autonomous agricultural production machines 3. The automated booking of this external service 71 may be performed by a customer 57 or by the autonomous agricultural production machine 3 itself. In this context, it may be provided that the external service 71 requested by the at least one or more autonomous agricultural production machines 3 and/or the customer 57 is a remote monitoring service and/or remote control service 71 distant from the particular agricultural production machine 2, which is enabled upon request and which is configured to perform remote monitoring and/or remote control of the at least one or more autonomous agricultural production machines 3.

The at least one agricultural production machine 2 to be monitored and/or controlled using the remote monitoring and/or remote control service 71 has, as previously described, means, such as at least one data processing device 14, a data transmitting device 15 and a data receiving device 16 for transmitting machine data and/or environment data at regular or irregular time intervals or in real time to a database 18 associated with the server 12. In so doing, the machine data and/or environment data may be collected in the database 18 and assigned to the particular autonomous agricultural production machine 3 and linked to other available data from the immediate environment of the autonomous agricultural production machine 3. The machine data and/or environment data saved in the database 18 of the server 12 may be structured in such a way that the assistance system 1 may access the autonomous agricultural production machine 3 at any time and take over its control.

Moreover, in one or some embodiments, the remote monitoring and/or remote control service 71 may comprise a geo-fence data record 72. The use of the geo-fence data record 72 by the one or more autonomous agricultural production machines 3 may cause the movement of the at least one or more autonomous agricultural production machines 3 to be limited to the territory 66 to be worked, so that the one or more autonomous agricultural production machines 2 do not leave the territory 66 to be worked in an uncontrolled manner.

In one or some embodiments, the assistance system 1 is such that it assigns the one or more autonomous agricultural production machines 3 to a main process 73 as a supporter 74, wherein the assistance system 1 determines the need for support in an environment of the one or more autonomous agricultural production machines 3 and assigns jobs 75 to the available autonomous agricultural production machines 3 depending on the identified need. For example, the main process 73 described in detail in FIG. 1, may be processed by manned and unmanned agricultural production machines, wherein the autonomous agricultural production machines 3 according to the invention may be designed, for example, as any one, any combination, or all of: loader wagons 27; forklifts 45; flatbed or transport trailers 46, 47; or the described self-propelled mower 53.

It is also provided that the customer 57 may pay a usage fee 76 for booking the remote monitoring and/or remote control service 71.

As a result, using the described assistance system 1 according to one or some embodiments of the invention, a driverless autonomous vehicle 2, which may be configured to independently perform driving movements 4 and work activities 5, may be provided with information 63 and equipment 64 depending on a deployment plan 55 in order to act as a specially designed autonomous agricultural production machine 3, and wherein the driving movements 4 and work activities 5 of the autonomous agricultural production machine 3 are at least partially remotely monitored and/or remotely controlled, and the remote monitoring and/or remote control may be performed at least partially using the assistance system 1.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Assistance system |
| 2 | Autonomous vehicle |
| 3 | Autonomous agricultural production machine |
| 4 | Driving movement |
| 5 | Work activity |
| 6 | Deployment planning module |
| 7 | Required information module |
| 8 | Control module |
| 9 | Basic data |
| 10 | Monitoring module |
| 11 | Data exchange |
| 12 | Server |
| 13 | Data cloud |
| 14a..n Data processing device | |
| 15a..n Data transmitting device | |
| 16a..n Data receiving device | |
| 17 | Memory unit |
| 18 | Database |
| 19 | Computing unit |
| 20 | Input/output unit |
| 21 | Basic vehicle |
| 22 | Basic vehicle |
| 23 | Tractor |
| 24 | Combine |
| 25 | Forage harvester |
| 26 | Attachment |
| 27 | Loader wagon |
| 28 | Baler |
| 29 | Forage harvester |
| 30 | Cultivated area |
| 31 | Harvested material |
| 32 | |
| 33 | |
| 34 | |
| 35 | Combine harvester |
| 36 | Agricultural production machine |
| 37 | Crop |
| 38 | Fruit |
| 39 | Grain tank |
| 40 | Straw |
| 41 | Swath |
| 42 | Tractor |
| 43 | Baler |
| 44 | Harvested material bales |
| 45 | Forklift |
| 46 | Flatbed trailer |
| 47 | Transport trailer |
| 48 | Transmitting and receiving unit |
| 49 | Stationary device |
| 50 | GPS signal |
| 51 | Machine fleet |
| 52 | Vehicle fleet |
| 53 | Self-propelled mower |
| 54 | Mowing attachment |
| 55 | Customer-specific deployment plan |
| 56 | Service |
| 57 | Customer |
| 58 | Result step |
| 59 | Chassis |
| 60 | Energy transmission means |
| 61 | Energy source |
| 62 | Result step |
| 63 | Information |
| 64 | Equipment |
| 65 | Result data record |
| 66 | Territory to be worked |
| 67 | Additional result data record |
| 68 | Control data |
| 69 | Obstacle |
| 70 | Automated booking |
| 71 | External service |
| 72 | Geo-fence data record |
| 73 | Main process |
| 74 | Supporter |
| 75 | Job |
| 76 | Usage fee |
| 77 | Processor |
| 78 | Memory |
| 79 | Communication interface |
| 80 | Communication interface |
| 81 | Communication interface |

1. An agricultural production machine assistance system configured to control an agricultural production machine to act as an autonomous agricultural production machine, the agricultural production machine assistance system comprising:
a communication interface configured to receive electronic data; and
at least one processor in communication with the communication interface and configured to:
plan deployment of the agricultural production machine;
transmit information to the agricultural production machine used by the agricultural production machine for the deployment of the agricultural production machine;
at least partly control the agricultural production machine in order to act as the autonomous agricultural production machine; and
monitor one or more aspects of the agricultural production machine at least partly during the deployment.

2. The agricultural production machine assistance system of claim 1, further comprising one or more data processing devices, one or more data receiving devices, and one or more data sending devices; and
wherein the one or more data processing devices, the one or more data receiving devices, and the one or more data sending devices are associated with one or more autonomous vehicles and an external server.

3. The agricultural production machine assistance system of claim 2, wherein the external server is configured as a data cloud.

4. The agricultural production machine assistance system of claim 1, wherein the agricultural production machine is unmanned and autonomously performs driving movements and working activities.

5. The agricultural production machine assistance system of claim 1, wherein the at least one processor is configured to receive a customer-specific deployment plan; and
wherein the customer-specific deployment plan describes a service to be provided, at least in terms of type and scope.

6. The agricultural production machine assistance system of claim 5, wherein the at least one processor is configured to plan deployment by generating a deployment plan;
wherein the at least one processor is configured to determine a required number of autonomous vehicles from the deployment plan; and
wherein the at least one processor is configured to arrange for provision of the required number of autonomous vehicles.

7. The agricultural production machine assistance system of claim 6, wherein the at least one processor is configured to assign information and equipment to the agricultural production machine from the deployment plan so that the agricultural production machine acts as the autonomous agricultural production machine executing driving movements and work activities derived from the customer-specific deployment plan.

8. The agricultural production machine assistance system of claim 7, wherein the at least one processor is configured to assign information and equipment to the agricultural production machine in a result data record, which transforms the agricultural production machine into an autonomous agricultural production machine.

9. The agricultural production machine assistance system of claim 5, wherein the at least one processor is configured to plan deployment by generating a deployment plan;
wherein the at least one processor is configured to generate a result data record from the deployment plan; and
wherein the result data record comprises control data that controls a particular autonomous agricultural production machine upon implementation of determined driving movements and working activities.

10. The agricultural production machine assistance system of claim 9, wherein the result data record is limited to basic data; and
wherein the result data record, upon transmission and execution by the agricultural production machine results in complete control of the agricultural production machine as the autonomous agricultural production machine for realizing the driving movements and the working activities being automatically triggered by the autonomous agricultural production machine itself.

11. The agricultural production machine assistance system of claim 5, wherein the at least one processor is configured to monitor the driving movement and work activity of one or more autonomous agricultural production machines; and
wherein the at least one processor is configured to intervene in controlling of a particular autonomous agricultural production machine responsive to identifying at least one critical situation.

12. The agricultural production machine assistance system of claim 11, wherein, responsive to an automated booking of an external service for the one or more autonomous agricultural production machines, the at least one processor is configured to monitor the driving movement and the work activity of the one or more autonomous agricultural production machines.

13. The agricultural production machine assistance system of claim 12, wherein the external service, requested by one or both of the one or more autonomous agricultural production machines or a customer, is one or both of a remote monitoring service or a remote control service distant from the one or more autonomous agricultural production machines; and
wherein the external service is configured to perform one or both of remote monitoring or remote control of the one or more autonomous agricultural production machines.

14. The agricultural production machine assistance system of claim 13, wherein the one or more autonomous agricultural production machines, for one or both of remote monitoring or remote control using one or both of the remote monitoring service or the remote control service, includes at least one data processing device, at least one data transmitting device, and at least one data receiving device for transmitting one or both of machine data or environment data at time intervals or in real time to a database assigned to a server;
wherein the one or both of the machine data or the environment data are collected in the database and assigned to a particular autonomous agricultural production machine and linked to further available data from an immediate environment of the particular autonomous agricultural production machine; and
wherein the one or both of the machine data or the environment data saved in the database of the server are structured in such a way that the agricultural production machine assistance system is configured to access the particular autonomous agricultural production machine and take over its control.

15. The agricultural production machine assistance system of claim 13, wherein the one or both of the remote monitoring service or the remote control service is configured to provide a geo-fence data record; and
wherein the one or more autonomous agricultural production machines are configured to use of the geo-fence data record thereby causing movement of the one or more autonomous agricultural production machines to be limited to a territory, defined by the geo-fence data record, to be worked.

16. The agricultural production machine assistance system of claim 13, wherein the at least one processor is configured to assign the one or more autonomous agricultural production machines to a main process as a supporter;
wherein the at least one processor is configured to determine need for support in an environment of the one or more autonomous agricultural production machines and to assign jobs to available autonomous agricultural production machines depending on the determined need.

17. The agricultural production machine assistance system of claim 13, wherein the one or both of the remote monitoring service or the remote control service is activated based on input from a user indicative of paying a usage fee.

18. An autonomous driverless agricultural production machine comprising:
at least one communication interface; and
at least one processor in communication with the at least one communication interface and configured to:
receive, from an agricultural production machine assistance system remote from the autonomous driverless agricultural production machine, information and equipment depending on a deployment in order to act as a specially designed autonomous agricultural production machine; and
perform, based on the information and the equipment, automatic driving movements and work activities that are one or both of at least partially remotely monitored or at least partially remotely controlled, wherein communication with the
assistance system results in one or both of remote monitoring or remote control.

19. The autonomous driverless agricultural production machine of claim 18, wherein the at least one processor is configured to perform the automatic driving movements and work activities that are both remotely monitored and remotely controlled via the communication with the agricultural production machine assistance system.
